(19) United States
(12) Patent Application Publication
(10) Pub. No.: US 2024/0150631 A1
(43) Pub. Date: May 9, 2024

(54) COMPOSITE PRODUCTS

(71) Applicant: KNAUF INSULATION SPRL, Vise (BE)

(72) Inventors: Carl HAMPSON, Liverpool (GB); Oliver CALLAGHAN, Manchester (GB)

(21) Appl. No.: 18/412,722

(22) Filed: Jan. 15, 2024

Related U.S. Application Data
(63) Continuation of application No. 17/042,096, filed on Sep. 26, 2020.

(30) Foreign Application Priority Data
Mar. 27, 2018 (GB) 1804907.2

(51) Int. Cl. C09J 179/02; B27N 3/00; B29C 70/08; C09J 105/00; C09J 161/34; D04H 1/587; D04H 3/12

(52) U.S. Cl. CPC C09J 179/02; B27N 3/002; B29C 70/08; C09J 105/00; C09J 161/34; D04H 1/587; D04H 3/12

(57) ABSTRACT

A method of manufacturing a composite product, comprising:
applying a binder composition, notably in the form of an aqueous solution, to non or loosely assembled matter to provide resinated matter, wherein the binder composition consists of a binder composition prepared by combining reactants comprising at least 50% by dry weight reducing sugar reactant(s) and at least 5% by dry weight nitrogen-containing reactant(s); and
arranging the resinated matter to provide loosely arranged resinated matter; and
subjecting the loosely arranged resinated matter to heat and/or pressure to cure the binder composition and to form the composite product;
wherein the nitrogen-containing reactant(s) comprise TPTA triprimary triamine(s), notably wherein the nitrogen-containing reactant(s) comprise at least 5% by dry weight of TPTA triprimary triamine(s).

The present invention relates to composite products and a method for their production. The present invention provides binder compositions with properties including excellent curing rates, bond strength, parting strength, tensile strength and low swelling properties, ease of handling and good storage stability.

In accordance with one aspect, the present invention provides a method of manufacturing a composite product, comprising:
applying a binder composition, notably in the form of an aqueous solution, to non or loosely assembled matter to provide resinated matter, wherein the binder composition consists of a binder composition prepared by combining reactants comprising at least 50% by dry weight reducing sugar reactant(s) and at least 5% by dry weight nitrogen-containing reactant(s); and
arranging the resinated matter to provide loosely arranged resinated matter; and
subjecting the loosely arranged resinated matter to heat and/or pressure to cure the binder composition and to form the composite product;
wherein the nitrogen-containing reactant(s) comprise TPTA triprimary triamine(s), notably wherein the nitrogen-containing reactant(s) comprise at least 5% by dry weight of TPTA triprimary triamine(s).

As used herein, the term “TPTA triprimary triamine(s)” means triprimary triamine(s) selected from:
triprimary triamine(s) having spacer groups between each of the three primary amines which consist of carbon chains;
triprimary triamine(s) having spacer groups between each of the three primary amines wherein each spacer group has a spacer length which is less than or equal to 12 polyvalent atoms; and
triprimary triamine(s) having a total number of polyvalent atoms which is less than or equal to 23.

In one preferred embodiment the TPTA triprimary triamine(s) comprise, and more preferably consist of, triprimary triamine(s) having spacer groups between each of the three primary amines which consist of carbon chains. In another preferred embodiment the TPTA triprimary triamine(s) comprise, and more preferably consist of, triprimary triamine(s) having spacer groups between each of the three primary amines wherein each spacer group has a spacer length which is less than or equal to 12 polyvalent atoms. In a further preferred embodiment the TPTA triprimary triamine(s) comprise, and more preferably consist of, triprimary triamine(s) having a total number of polyvalent atoms which is less than or equal to 23.

In accordance with another aspect, the present invention provides a composite product, manufactured by a method comprising:
applying a binder composition, notably in the form of an aqueous solution, to non or loosely assembled matter to provide resinated matter, wherein the binder composition consists of a binder composition prepared by combining reactants comprising at least 50% by dry weight reducing sugar reactant(s) and at least 5% by dry weight nitrogen-containing reactant(s); and
arranging the resinated matter to provide loosely arranged resinated matter; and
subjecting the loosely arranged resinated matter to heat and/or pressure to cure the binder composition and to form the composite product;
wherein the nitrogen-containing reactant(s) comprise TPTA triprimary triamine(s), notably wherein the nitrogen-containing reactant(s) comprise at least 5% by dry weight of TPTA triprimary triamine(s).

According to a further aspect, the present invention provides a method of manufacturing a composite product comprising;
applying a binder composition, notably in the form of an aqueous solution, to non or loosely assembled matter to provide resinated matter, wherein the binder composition consists of a binder composition prepared by combining reactants consisting of between 60% and 95% by dry weight reducing sugar reactant(s) and between 5% and 40% by dry weight nitrogen-containing reactant(s); and
   arranging the resinated matter to provide loosely arranged resinated matter; and
   subjecting the loosely arranged resinated matter to heat and/or pressure to cure the binder composition and to form the composite product;
   wherein the nitrogen-containing reactant(s) comprise at least 95 wt % of triprimary triamine(s) having spacer groups between each of the three primary amines which consist of carbon chains.

The non or loosely assembled matter may comprise woven or non-woven fiber material. The non or loosely assembled matter may be selected from fibers, notably selected from inorganic fibers, man-made organic fibers, mineral fibers, stone fibers, glass fibers, aramid fibers, ceramic fibers, metal fibers, carbon fibers, polyimide fibers, polyester fibers, rayon fibers, cellulosic fibers and combinations thereof. The non or loosely assembled matter may be selected from particulates, notably selected from inorganic particles, sand and coal, natural fibers, jute, flax, hemp, straw and combinations thereof.

The composite product may be mineral fiber insulation product, for example glass wool, a glass fiber mat, stone wool or stone fiber mat. The composite products may be mineral fiber veil, e.g. a glass fiber veil, which may then find application for example in battery separators, as substrate for roofing products such as roofing membranes or shingles, or other membranes. The composite product may be prepregs, high pressure laminates, refractory bricks, foundry sands, brake pads, corrugated cardboard.

The composite product may be a high pressure laminate. According to this aspect the present invention provides a method of manufacturing a high pressure laminate comprising:
providing a binder impregnated core layer by impregnating cellulosic fibrous sheets, notably kraft paper sheets with a binder composition
providing a semi-finished assembly by assembling the binder impregnated core layer with a surface layer; and
applying heat and/or pressure to the semi-finished assembly to cure the binder composition in the binder impregnated core layer and secure the core layer and the surface layer together to form the high pressure laminate;
   wherein the binder composition consists of a binder composition prepared by combining reactants comprising at least 50% by dry weight reducing sugar reactant(s) and at least 5% by dry weight nitrogen-containing reactant(s); and
   wherein the nitrogen-containing reactant(s) comprise TPTA triprimary triamine(s), notably wherein the nitrogen-containing reactant(s) comprise at least 5% by dry weight of TPTA triprimary triamine(s).

The composite product may be a corrugated cardboard. According to this aspect the present invention provides a method of manufacturing a corrugated cardboard comprising:
applying a binder composition between the fluted corrugated sheet and the one or two flat linerboards; and
applying heat and/or pressure to cure the binder composition to form the corrugated cardboard;
   wherein the binder composition consists of a binder composition prepared by combining reactants comprising at least 50% by dry weight reducing sugar reactant(s) and at least 5% by dry weight nitrogen-containing reactant(s); and
   wherein the nitrogen-containing reactant(s) comprise TPTA triprimary triamine(s), notably wherein the nitrogen-containing reactant(s) comprise at least 5% by dry weight of TPTA triprimary triamine(s).

According to a further aspect, the present invention provides a method of manufacturing a composite mineral fiber product selected from a non-woven veil, glass wool insulation and stone wool insulation comprising;

applying a binder composition in the form of an aqueous solution to non or loosely assembled mineral fibers to provide resinated mineral fibers, wherein the binder composition consists of a binder composition prepared by combining reactants consisting of between 60% and 95% by dry weight reducing sugar reactant(s) and between 5% and 40% by dry weight nitrogen-containing reactant(s); and
arranging the resinated mineral fibers to provide loosely arranged resinated mineral fibers; and
subjecting the loosely arranged resinated mineral fibers to heat to cure the binder composition and to form the composite mineral fiber product;
wherein the nitrogen-containing reactant(s) comprise at least 95 wt % of triprimary triamine(s) having spacer groups between each of the three primary amines which consist of carbon chains.

According to a further aspect the present invention provides a method of manufacturing a composite product as defined in claim 1. The dependent claims define preferred or alternative embodiments.

Any feature described herein in relation to a particular aspect of the invention may be used in relation to any other aspect of the invention.

The term “binder composition” as used herein means all ingredients applied to the non or loosely assembled matter and/or present on the non or loosely assembled matter, notably prior to curing, (other than the non or loosely assembled matter itself and any moisture in the non or loosely assembled matter), including reactants, solvents (including water) and additives. The term “dry weight of the binder composition” as used herein means the weight of all components of the binder composition other than any water that is present (whether in the form of liquid water or in the form of water of crystallization). The reactants may make up ≥80%, ≥90% or ≥95% and/or ≤99% or ≤98% by dry weight of the binder composition.

The binder composition applied to the non or loosely assembled matter comprises reactants which cross-link when cured to form a cured binder which holds the non or loosely assembled matter together to form the composite product. The binder composition comprises reactants that will preferably form a thermoset resin upon curing.

The binder composition is preferably free of, or comprises no more than 2 wt %, no more than 5 wt % or no more than 10 wt % of urea formaldehyde (UF), melamine urea formaldehyde (MUF) and/or phenol formaldehyde.

The binder composition is preferably a “no added formaldehyde binder” that is to say that none of ingredients used to form the binder composition comprise formaldehyde. It may be “substantially formaldehyde free”, that is to say that it liberates less than 5 ppm formaldehyde as a result of drying and/or curing (or appropriate tests simulating drying and/or curing); more preferably it is “formaldehyde free”, that is to say that it liberates less than 1 ppm formaldehyde in such conditions.

The term “loosely arranged resinated matter” as used herein means that the resinated matter is assembled together with sufficient integrity for the resinated matter to be processed along a production line but without the resinated matter being permanently joined together in a way that is achieved by fully cross-linking the binder composition. Prior to curing, the binder composition preferably provides a stickiness or tackiness which holds the loosely arranged resinated matter together.

Preferably, the binder composition is a reducing sugar based binder composition, that is to say that at least 50 wt % of the reactants comprise reducing sugar(s) and/or reaction products of reducing sugar(s). The binder composition may be prepared by combining reactants comprising, consisting essentially of or consisting of the reducing sugar reactant(s) and the nitrogen-containing reactant(s). In the form in which it is applied to the non or loosely assembled matter the binder composition may comprise (a) the reducing sugar reactant(s) and the nitrogen-containing reactant(s) and/or (b) curable reaction product(s) of the reducing sugar reactant(s) and the nitrogen-containing reactant(s).

As used herein, the term “consist or consisting essentially of” is intended to limit the scope of a statement or claim to the specified materials or steps and those that do not materially affect the basic and novel characteristic(s) of the invention.

The reducing sugar reactant(s) may comprise: a monosaccharide, a monosaccharide in its aldose or ketose form, a disaccharide, a polysaccharide, a triose, a tetrose, a pentose, xylose, a hexose, dextrose, fructose, a heptose, or mixtures thereof. The reducing sugar reactant(s) may be yielded in situ by carbohydrate reactant(s), notably carbohydrate reactant(s) having a dextrose equivalent of at least about 50, at least about 60, at least about 70, at least about 80 or at least about 90, notably carbohydrate reactant(s) selected from the group consisting of molasses, starch, starch hydrolysate, cellulose hydrolysates, and mixtures thereof. The reducing sugar reactant(s) may comprise or consist of a combination of dextrose and fructose, for example in which the combination of dextrose and fructose makes up at least 80 wt % of the reducing sugar reactant(s) and/or in which the dextrose makes up at least 40 wt % of the reducing sugar reactant(s) and/or in which the fructose makes up at least 40 wt % of the reducing sugar reactant(s); the reducing sugar reactant(s) may comprise or consist of high fructose corn syrup (HFCS). The reducing sugar reactant(s) may comprise or consist of reducing sugar reactant(s) yielded in situ by sucrose. The reducing sugar reactant(s) may comprise reducing sugar reactant(s) selected from the group consisting of xylose, arabinose dextrose, mannose, fructose and combinations thereof, for example making up at least 80 wt % of the reducing sugar reactant(s).

As used herein, the term “nitrogen-containing reactant(s)” means one or more chemical compound which contain(s) at least one nitrogen atom and which is/are capable of reacting with the reducing sugar reactant(s); preferably the nitrogen-containing reactant(s) consist of Maillard reactant(s), that is to say reactant(s) which is/are capable of reacting with the reducing sugar reactant(s) as part of a Maillard reaction.

The nitrogen-containing reactant(s) comprise, and may consist essentially of or consist of, triprimary triamine(s) having spacer groups between each of the three primary amines which consist of carbon chains. The triprimary triamine(s) may be selected from the group consisting of triaminodecanes, triaminononanes, notably 4-(am inomethyl)-1,8-octanediamine, triaminooctanes, triaminoheptanes, notably 1,4,7-triaminoheptane, triaminohexanes, notably 1,3,6-triaminohexane, triaminopentanes, and including isomers and combination thereof.

As used herein the term “triprimary triamine(s)” means organic compound having three and only three amines, each of the three amines being primary amines (—NH₂). One, two or each of the primary amine(s) of the triprimary triamine(s) may be present in the form of a salt, e.g as an ammonium group (—NH₃⁺).

As used herein, the term “spacer group” in the terminology “the spacer group(s) separating each of the three primary amines” means a chain separating two primary amines. As used herein, the term “the spacer group(s) separating each primary amines in the molecule consists of carbon chains” means that the spacer group(s) consist only of carbon atoms bonded to hydrogen atoms or bonded to other carbon atoms. The triprimary triamine(s) having spacer groups between each of the three primary amines which consist of carbon chains thus consist of the three primary amines and carbon and hydrogen atoms. For example, when the spacer group(s) separating each primary amine in the molecule consists of carbon chains, no heteroatoms are present in the spacer groups.

The spacer group(s) may be selected from the group consisting of alkanediyls, heteroalkanediyls, alkenediyls, heteroalkenediyls, alkynediyls, heteroalkynediyls, linear alkanediyls, linear heteroalkanediyls, linear alkenediyls, linear heteroalkenediyls, linear alkynediyls, linear heteroalkynediyls, cycloalkanediyls, cycloheteroalkanediyls, cycloalkenediyls, cycloheteroalkenediyls, cycloalkynediyls and cycloheteroalkynediyls, each of which may be branched or unbranched. The spacer group(s) may be selected from the group consisting of alkanediyls, alkenediyls, alkynediyls, linear alkanediyls, linear alkenediyls, linear alkynediyls, cycloalkanediyls, cycloalkenediyls and cycloalkynediyls, each of which may be branched or unbranched. The spacer group may comprise or may be devoid of halogen atoms. The spacer groups may comprise or be devoid of aromatic groups. As used herein: the term “alkanediyl” means a saturated chain of carbon atoms ie without carbon-carbon double or triple bonds; the term “alkenediyl” means a chain of carbon atoms that comprises at least one carbon-carbon double bond; the term “alkynediyl” means a chain of carbon atoms that comprises at least one carbon-carbon triple bond; the term “cyclo” in relation to cycloalkanediyl, cycloalkenediyl and cycloalkynediyl indicates that at least a portion of the chain is cyclic and also includes polycyclic structures; and the term “linear” in relation to alkanediyls, alkenediyls and alkynediyls indicates an absence of a cyclic portion in the chain. As used herein, the term “hetero” in relation to heteroalkanediyls, heteroalkenediyls, heteroalkynediyls, linear heteroalkanediyls, linear heteroalkenediyls, linear heteroalkynediyls, cycloheteroalkanediyls, cycloheteroalkenediyls, and cycloheteroalkynediyls means that the chain comprises at least one polyvalent heteroatom. As used herein, the term heteroatom is any atom that is not carbon or hydrogen. As used herein, the term polyvalent atom means an atom that is able to be covalently bonded to at least 2 other atoms. The polyvalent heteroatom may be oxygen; it may be silicon; it may be sulfur or phosphorus. One, two or preferably each of the spacer groups may have a total number of polyvalent atoms, or a total number of carbon atoms which is ≥3, ≥4 or ≥5 and/or ≤12, ≤10 or ≤9. One, two or preferably each of the spacer groups may have a spacer length which is ≥3, ≥4 or ≥5 and/or ≤12, ≤10 or ≤9. As used herein, the term “spacer length” in relation to a spacer group separating two primary amines means the number of polyvalent atoms which form the shortest chain of covalently bonded atoms between the two primary amines. Each of the spacer groups between the three primary amines of the TPTA triprimary triamine(s) may: consist of an alkanediyl; and/or be linear; and/or be unbranched; and/or have a number of carbon atoms which is ≥3 or ≥4 and/or ≤9 or ≤8; and or have a spacer length which is ≥3 or ≥4 and/or ≤9 or ≤8. The total number of the polyvalent atoms of the TPTA triprimary triamine(s) may be ≥9, ≥11 or ≥12 and/or ≤23, ≤21, ≤19 or ≤17.

The nitrogen-containing reactant(s) may comprise reactant(s) selected from the group consisting of: inorganic amines, organic amines, organic amines comprising at least one primary amine, salts of an organic amine comprising at least one primary amine, polyamines, polyprimary polyamines and combinations thereof, any of which may be substituted or unsubstituted. The nitrogen-containing reactant(s) may comprise NH₃, NH₃ may be used as such (e.g. in form of an aqueous solution), or as an inorganic or organic ammonium salt, for example ammonium sulfate, ammonium phosphate, e.g. diammonium phosphate or ammonium citrate, e.g. triammonium citrate, or as a source of NH₃, e.g. urea. In one preferred embodiment, the nitrogen-containing reactant(s) comprise ammonium sulfate. In another preferred embodiment, the nitrogen-containing reactant(s) comprise ammonium citrate. As used herein, the term “polyamine” means any organic compound having two or more amine groups and the term “polyprimary polyamine” means an organic compound having two or more primary amines (—NH₂). As used herein the term “substituted” means the replacement of one or more hydrogen atoms with other functional groups. Such other functional groups may include hydroxyl, halo, thiol, alkyl, haloalkyl, heteroalkyl, aryl, arylalkyl, arylheteroalkyl, nitro, sulfonic acids and derivatives thereof, carboxylic acids and derivatives thereof.

The polyprimary polyamine may be a diamine, triamine, tetramine, or pentamine. As used herein the term “diamine” means organic compound having two (and only two) amines, “triamine” means organic compound having three (and only three) amines, “tetramine” means organic compound having four (and only four) amines and “pentamine” means organic compound having five (and only five) amines. For example, the polyprimary amine may be: a triamine selected from diethylenetriamine (which is a diprimary triamine, i.e. diethylenetriamine has three amines, two of them being primary amines) or bis(hexamethylene)triamine; a tetramine, notably triethylenetetramine; or a pentamine, notably tetraethylenepentamine. The polyprimary polyamine may comprise diprimary diamine, notably 1,6-diaminohexane (hexamethylenediamine, HMDA) or 1,5-diamino-2-methylpentane (2-methyl-pentamethylenediamine).

The binder composition may comprise, consist essentially of or consist of a binder composition prepared by combining reactants wherein:
the reducing sugar reactant(s) make up:
   ≥50%, ≥60%, ≥70% by dry weight of the reactant(s), and/or
   ≤97%, ≤95%, ≤90%, ≤85% by dry weight of the reactant(s), and/or the nitrogen-containing reactant(s) make up:
   ≥3%, ≥5%, ≥7%, ≥10%, ≥15% by dry weight of the reactant(s), and/or
   ≤50%, ≤40%, ≤30%, ≤25% by dry weight of the reactant(s).

The binder composition may comprise, consist essentially of or consist of a binder composition prepared by combining reactants consisting of between 60% and 95% by dry weight reducing sugar reactant(s) and between 5% and 40% by dry weight nitrogen-containing reactant(s). The TPTA triprimary triamine(s) may make up:
≥3%, ≥5%, ≥7%, ≥10%, ≥15%, and/or
≤40%, ≤35%, ≤30%, ≤25% by dry weight of the reactants of the binder composition.

The TPTA triprimary triamine(s) may make up:
≥5%, ≥10%, ≥10%, ≥20%, ≥30%, ≥40%, ≥50%, ≥60%, ≥65%; and/or
≤95%, ≤90%, ≤85%, ≤80%, ≤70%, ≤60%, ≤50%, ≤45%, ≤30%
   by dry weight of the nitrogen-containing reactants.

The TPTA triprimary triamine(s) may make up: ≥90% and ≤99%; or ≥80% and ≤90%; or ≥60% and ≤80%; by dry weight of the nitrogen-containing reactants. Particularly in the aforementioned cases, the remaining nitrogen-containing reactants may comprise amines and/or nitriles.

When the nitrogen-containing reactant(s) comprise nitrogen-containing reactant(s) other than TPTA triprimary triamine(s), the and notably each nitrogen-containing reactant other than TPTA triprimary triamine(s), may make up:
≥3%, ≥5%, ≥7%, ≥10%, ≥15%, and/or
≤40%, ≤35%, ≤30%, ≤25%
   by dry weight of the reactants of the binder composition.

The and notably each nitrogen-containing reactant other than TPTA triprimary triamine(s), may make up:
≥5%, ≥10%, ≥15%, ≥20%, ≥30%, ≥40%, ≥50%, ≥60%, ≥65%; and/or
≤95%, ≤90%, ≤85%, ≤80%, ≤70%, ≤60%, ≤50%, ≤45%, ≤30% by dry weight of the nitrogen-containing reactants.

The ratio of carbonyl groups in the reducing sugar reactant(s) to reactive amino groups in the nitrogen-containing reactant(s) may be in the range of 5:1 to 1:2. For example, the ratio of carbonyl groups to reactive amino groups may be in the range of 5:1 to 1:1.8, 5:1 to 1:1.5, 5:1 to 1:1.2, 5:1 to 1:1, 5:1 to 1:0.8 and 5:1 to 1:0.5. Further examples include ratios such as 4:1 to 1:2, 3.5:1 to 1:2, 3:1 to 1:2, 2.5:1 to 1:2, 2:1 to 1:2 and 1.5:1 to 1:2. As used herein, the term “reactive amino group” means any amino group in the nitrogen-containing reactant(s) which is capable of reacting with the reducing sugar reactant(s). Specifically, examples of such reactive amino groups comprise primary and secondary amine(s).

The nitrogen-containing reactant(s) and the reducing sugar reactant(s) preferably are Maillard reactants. The nitrogen-containing reactant(s) and the reducing sugar reactant(s) (or their reaction product(s)) preferably react to form Maillard reaction products, notably melanoidins when cured. Curing of the binder composition may comprise or consist essentially of Maillard reaction(s). Preferably, the cured binder consists essentially of Maillard reaction products. The cured binder composition may comprise melanoidin-containing and/or nitrogenous-containing polymer(s); it is preferably a thermoset binder and is preferably substantially water insoluble.

The binder composition and/or the cured binder may comprise ester and/or polyester compounds.

The binder composition may be prepared by combining all the reducing sugar reactant(s) and all the nitrogen-containing reactant(s) in a single preparation step, for example by dissolving the reducing sugar reactant(s) in water and then adding the nitrogen-containing reactant(s). The term “single preparation step” is used herein to differentiate from a “multiple preparation step” preparation in which a first portion of reactants are combined and stored and/or allowed to react for a pre-determined time before addition of further reactants.

Alternatively, the binder composition may be prepared by:
combining reducing sugar reactant(s), notably all of the reducing sugar reactant(s), with a first portion of the nitrogen-containing reactant(s) to provide an intermediate binder composition,
storing the intermediate binder composition; and
combining the intermediate binder composition with a second portion of the nitrogen-containing reactant(s) to provide the binder composition.

The intermediate binder composition may comprise, consist essentially of or consist of reaction products of the reducing sugar reactant(s), with a first portion of the nitrogen-containing reactant(s). The reactants may be heated to provide the intermediate binder composition; the intermediate binder composition may be subsequently cooled.

The first and second portions of nitrogen-containing reactant(s) may be the same nitrogen-containing reactant(s) or, alternatively they may be different nitrogen-containing reactant(s). Only one of the first and second portion of nitrogen-containing reactant(s), or alternatively each of the first and second portion of nitrogen-containing reactant(s), may comprise, consist essentially of or consist of TPTA triprimary triamine(s).

As used herein “storing the intermediate binder composition” means that the intermediate binder composition is stored or shipped for a prolonged time, notably without crystallization of the reducing sugar reactant(s) or gelling which would render the binder composition unusable. The intermediate binder composition may be stored for a period of at least 30 min, at least 1 h, at least 4 h, at least 12 h, at least 24 h, at least 96 h, at least 1 week, at least 2 weeks, or at least 4 weeks.

The binder composition may comprise one or more additive, for example one or more additives selected from dedusting oil, waxes, dyes, release agents, formaldehyde scavengers (for example urea, tannins, quebracho extract, ammonium phosphate, bisulfite), water repellent agent, silanes, silicones, lignins, lignosulphonates and non-carbohydrate polyhydroxy component selected from glycerol, polyethylene glycol, polypropylene glycol, trimethylolpropane, pentaerythritol, polyvinyl alcohol, partially hydrolyzed polyvinyl acetate, fully hydrolyzed polyvinyl acetate, or mixtures thereof. Such additives are generally not reactants of the binder composition, that is to say they so do not cross-link with the reducing sugar and/or the nitrogen containing reactant(s) (or reaction products thereof) as part of the curing of the binder composition.

The binder composition may be applied to the non or loosely assembled matter in the form of a liquid, notably in the form of an aqueous composition, for example comprising an aqueous solution or dispersion, notably in which the dry weight of the aqueous binder composition makes up: ≥5 wt %, ≥10 wt %, ≥15 wt %, ≥20 wt % or ≥25 wt and/or ≤95 wt %, ≤90 wt %, ≤85 wt % or ≤80 wt % of the total weight of the aqueous binder composition. Alternatively, the binder composition may be applied to the non or loosely assembled matter in the form of a solid, for example as a powder or as particles. The binder composition may be applied by being sprayed. The binder composition may be applied to the non or loosely assembled matter by passing the non or loosely assembled matter through a spray of the binder composition or by spraying the binder composition over the the non or loosely assembled matter. The binder composition may be applied by being spread, for example as a continuous layer or as a discontinuous layer, for example as lines of binder. Other application techniques include roll application, dip coating and dry mixing.

In one aspect, the binder composition may be used to make mineral fiber insulation products. The method of producing a mineral fiber insulation product may comprise the sequential steps of:
forming a mineral melt from a molten mineral mixture
forming mineral fibers from the mineral melt
spraying the binder composition, notably as an aqueous composition, on to the mineral fibers, notably spraying the binder composition on to airborne mineral fibers subsequent to formation of the fibers and prior to collection of the fibers to form a blanket of mineral fibers;
collecting the mineral fibers to which the binder composition has been applied to form a blanket of mineral fibers; and
curing the binder composition by passing the blanket of mineral fibers through a curing oven.

Prior to curing, the mineral fibers to which the binder composition has been applied may be collected to form a primary blanket of mineral fibers which is subsequently folded over itself, for example using a pendulum mechanism, to produce a secondary blanket comprising superimposed layers of the primary blanket.

The dry weight of the aqueous binder composition, notably when applied to the mineral fibers, may make up: ≥5 wt %, ≥7.5 wt %, ≥10 wt %, ≥12 wt % and/or ≤20 wt %, ≤18 wt %, ≤15 wt % of the total weight of the aqueous binder composition.

The curing oven may have a plurality of heating zones having temperatures within the range 200° C. to 350° C. (typically 230° C. to 300° C.). A thin, low density product (12 kg/m³ or less) may be cured by passing through the curing oven in as little as 20 seconds; a thick, high density product (80 kg/m³ or more) may require a passage of 15 minutes or more in the curing oven. The blanket of mineral fibers may reach a temperature in the range 180° C.-220° C. during the curing process. The duration of passage of the blanket through the curing oven may be ≥0.5 minutes, ≥1 minute, ≥2 minutes, ≥5 minutes or ≥10 minutes and/or ≤50 minutes, ≤40 minutes or ≤30 minutes.

The quantity of cured binder in the cured blanket of mineral fibers may be ≥1%, ≥2%, ≥2.5%, ≥3%, ≥3.5% or ≥4% and/or ≤10% or ≤8%. This may be measured by loss on ignition (LOI).

When the composite product is a mineral fiber insulation product, the product may have one or more of the following characteristics:
a density greater than 5, 8 or 10 kg/m³;
a density less than 200, 180 or 150 km/m 3
comprise glass fibers and have a density greater than 5, 8 or 10 kg/m³ and/or less than 80, 60 or 50 kg/m³;
comprise stone fibers and have a density greater than 15, 20 or 25 kg/m³ and/or less than 220, 200 or 180 kg/m³;
a thermal conductivity A of less than 0.05 W/mK and/or greater than 0.02 W/mK measured at 10° C. notably in accordance with EN12667;
comprise less than 99% by weight and/or more than 80% by weight mineral fibers;
a thickness of greater than 10 mm, 15 mm or 20 mm and/or less than 400 mm, 350 mm or 300 mm.

The mineral fiber insulation product, notably when it is a low or medium density mineral fiber insulation product, may have
a nominal thickness in the range 60-260 mm; and/or
a thermal resistance R of 3 m 2 K/W, preferably 4 m 2 K/W at a thickness or 200 mm; and/or a density in the range 5-40 kg/m³, particularly 5-18 kg/m³ or 7-12 kg/m³.

The mineral fiber insulation product, notably when it is a high density mineral fiber insulation product, may have
a nominal thickness in the range 20 to 200 mm; and/or
a thermal resistance R of 0.7 m 2 K/W, preferably m 2 K/W at a thickness or 100 mm; and/or
a density in the range 100 to 200 kg/m³, particularly 130 to 190 kg/m³.

Use of a binder composition as described herein and wherein the TPTA triprimary triamine(s) makes up 0%, %, 20% and/or 25%, 30%, 35% by dry weight of the nitrogen-containing reactants may be particularly advantageous for mineral fiber insulation product, notably high density mineral fiber insulation products.

According to one aspect, the binder composition may be used to make a mineral fiber veil. The mineral fiber veil may be manufactured by a wet laid process or a dry laid process. The method of producing the mineral fiber veil may comprise the sequential steps of:
forming a mineral fiber web, notably the mineral fiber web may be formed by i) pouring a dispersion of fibers in water, notably chopped mineral fibers, on to a perforated conveyor belt (often referred to as a wire) through which the water is drained to form a non-woven web of fibers or ii) projecting fibers in an airstream towards of perforated conveyor to form a web of non-woven fibers;
applying the binder composition, notably as an aqueous composition, on to the mineral fibers, notably by coating the aqueous binder composition on to the mineral fiber web; and
curing the binder composition by passing the resinated mineral fiber web through a curing oven.

When the composite product is a mineral fiber veil, the quantity of cured binder in the final product may be ≥1%, ≥2.5%, ≥5%, ≥7.5%≥10%, or ≥12.5% and/or ≥25%, ≥22.5%, ≥20% or ≥17.5%. This may be measured by loss on ignition (LOI).

The thickness of the mineral fiber veil may be ≤0.1 mm or ≤0.3 mm and/or ≤0.8 mm or ≤0.6 mm. When the mineral fiber veil is a glass veil, the thickness may be ≥0.3 mm and ≤0.6 mm. The mineral fiber veil may have a surface weight ≥20 g/m² or ≥30 g/m² or ≥40 g/m² or ≥50 g/m² and/or ≤60 g/m² or ≤80 g/m² or ≤100 g/m² or ≤150 g/m² or ≤350 g/m².

Use of a binder composition as described herein and wherein the TPTA triprimary triamine(s) makes up 15%, 20% and/or 40%, 50% by dry weight of the nitrogen-containing reactants may be particularly advantageous for mineral fiber veils.

Methods of manufacturing composite products according to the present invention allow for cure speeds which are at least equivalent to and indeed faster than those obtained with comparable binder systems; similarly, the dry tensile strength of the cured composite products is at least equivalent to and indeed in some cases improved when compared to that obtained with comparable binder systems. Surprisingly, the wet strength of composite products manufactured according to the present invention is significantly improved with respect to that obtained with comparable binder systems. The wet strength provides an indication of the performance after aging and/or after weathering. This is unexpected as it is generally expected that the wet strength of a composite product will be lower than but proportional to its dry strength. Without wishing to be being bound by theory, it is believed that the improved properties of the binder compositions of the present invention are due to the use of TPTA triprimary triamine(s) and particularly due to the spacer groups being carbon chains with an absence of heteroatoms within the spacer groups and/or due to the spatial geometry of the TPTA triprimary triamine(s) molecules.

Embodiment of the invention will now be described, by way of example only, with reference to the accompanying figures of which:

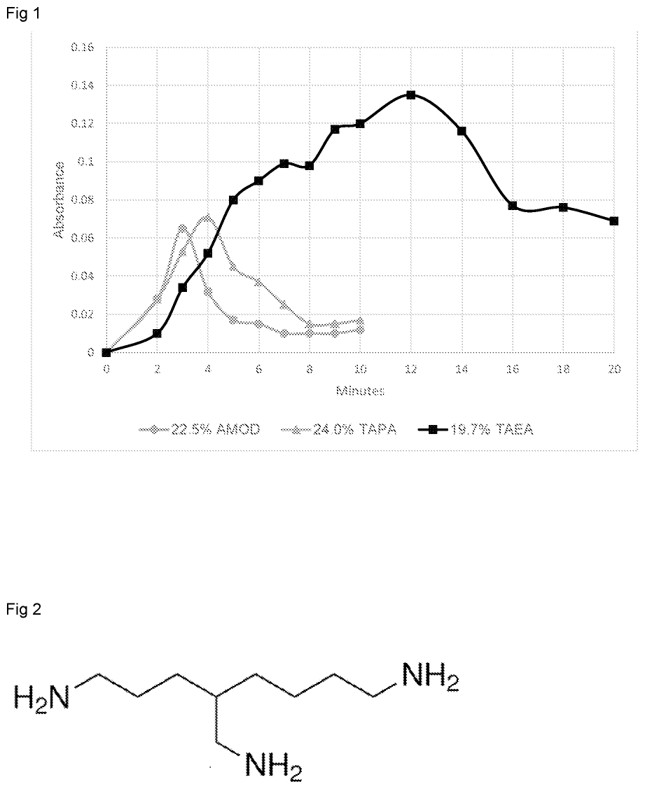

FIG. 1 shows cure results of a laboratory cure test of triprimary polyamines

FIG. 2 shows 4-(aminomethyl)-1,8-octanediamine (“AMOD”); and

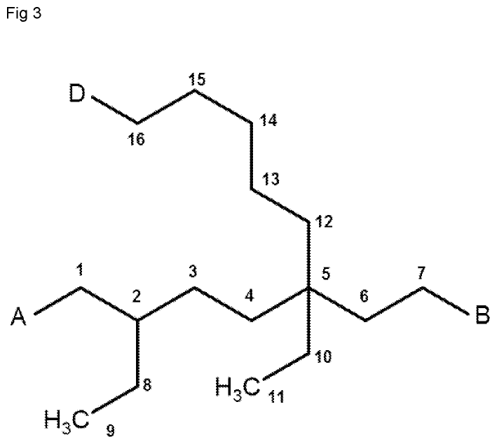

FIG. 3 shows an example of a TPTA triprimary triamine.

Examples made on mineral fiber veil are representative of improved properties obtained with TPTA triprimary amine(s) for composite products, notably glass wool insulation and stone wool insulation products.

### Example 1: Laboratory Indication of Cure Speed with HFCS

The following binder compositions were prepared by combining a nitrogen containing reactant and a reducing sugar reactant:

| Binder | | % dry | |
|---|---|---|---|
| composition | nitrogen containing reactant | weight | Notes |
| 1a | AMOD (4-(aminomethyl)- | 22.5% | a TPTA |
| | 1,8-octanediamine | | triprimary |
| | | | triamine |
| 1b | TAPA (tris(3-aminopropyl)amine) | 24.0% | a triprimary |
| | | | tetramine |
| 1c | TAEA (tris(2-aminoethyl)amine) | 19.7% | a triprimary |
| | | | tetramine |

The nitrogen containing reactants of binder compositions 1b and 1c are not TPTA triprimary triamines and thus provide comparative examples. Each of the binder compositions was prepared by combining the nitrogen containing reactant with HFCS 42 (high fructose corn syrup with 42% fructose+52% dextrose+trace quantities of other saccharides) in water to obtain a solution/dispersion containing 1 molar equivalent of triprimary polyamine to 3.31 molar equivalents of reducing sugars. The amounts of triprimary polyamines used in the binder compositions are expressed above and in FIG. 1 as dry weight % (the remaining dry weight being the HFCS 42) and the binder compositions were prepared at 22.5% total solids weight. Each binder composition was formulated to give a primary amine to carbonyl molar ratio on 1:1.105. FIG. 1 shows the light absorbance of leachates from glass fiber filters: drops of the binder compositions were applied to the glass fiber filters which were then were placed in an oven at 107° C. and subsequently removed after set time intervals. Brown polymers were formed on the filters, then dissolved in water and the absorbance of the leachate measured using a spectrophotometer. The evolution of the formation of soluble brown polymers and insoluble polymers provides an initial laboratory indication of curing and cure speed for these type of binders.

FIG. 1 shows that binder composition 1a using AMOD (4-(aminomethyl)-1,8-octanediamine, a TPTA triprimary triamine) shows a faster curing rate compared to binder composition 1 b using TAPA (tris(3-aminopropyl)amine) and binder composition 1c using TAEA (tris(2-aminoethyl)amine) which are both triprimary tetramines.

### Example 2

Examples of binder compositions tested on mineral fiber veils are shown in Table 1 with their respective mean dry veil tensile strengths and mean wet tensile strengths.

In each case, a nitrogen containing reactant comprising a triprimary polyamine was combined with HFCS 42 (high fructose corn syrup with 42% fructose+52% dextrose+trace quantities of other saccharides) in water to obtain a solution/dispersion containing 1 molar equivalent of triprimary polyamine to 3.31 molar equivalent of reducing sugars. The amounts of triprimary polyamines used in the binder compositions are expressed in Table 1 as dry weight %, the remaining dry weight being the HFCS, and the binder compositions were prepared at 2% weight (bake out solids). Once the binder compositions were prepared, they were applied to A4 size glass veil and the glass veils were cured to obtain a quantity of cured binder in the final product of 10% LOI (loss on ignition).

Measurement of dry glass veil tensile strength:

8 pieces of cured glass veil with a dimension of 14.8 cm×5.2 cm were cut from the cured A4 size veil and subjected to tensile testing by attaching a 50 Kg load cell using glass veil tensile plates on a testometric machine (TESTOMETRIC M350-10CT). The average of the total force in Newtons of the breaking strength is given in the table below. For the measurement of wet glass veil tensile strength, the veil samples are tested wet after being immersed in water at 80° C. for 10 minutes.

The column of wet strength % gives the % of mean wet tensile strength with respect to the % mean dry tensile strength.

TABLE 1

| Triprimary | Mean | Mean | |
|---|---|---|---|
| polyamine | dry tensile | wet tensile | wet |
| (% dry weight) | strength (N) | strength (N) | strength % |
| TAEA (19.7%) | 73.5 | 25.3 | 31.7% |
| TAPA (24.0%) | 80.9 | 31.4 | 38.8% |
| AMOD (22.5%) | 75.3 | 41.4 | 55.0% |

The results show that all the triprimary polyamines give good dry tensile strengths with TAPA giving a slightly better dry tensile strength compared to AMOD and TAEA. In regard of the wet tensile strengths, AMOD show better results compared to TAPA and TAEA. It is unexpected that the wet strength for AMOD was 55% of the value of the dry tensile strength while for TAPA it was only of 38.8%.

### Example 3: Examples of a Binder Composition for Mineral Fiber Insulation Products

A binder composition was prepared by combining reactants consisting of 90 parts by weight dextrose monohydrate and 10 parts by dry weight nitrogen-containing reactant where the nitrogen-containing reactant was 4-(aminomethyl)-1,8-octanediamine. This binder composition was suitable for providing appropriate properties when used as a binder composition for mineral wool insulation.

### Example 4: Examples of Binder Composition for Mineral Fiber Veils are Shown in Table 2

TABLE 2

| Test Ref | Binder composition (% dry weight) |
|---|---|
| A | 77.5% HFCS + 13.5% AMOD + 9% AS |
| B | 77.5% HFCS + 9% AMOD + 13.5% AS |
| C | 77.5% HFCS + 11.25% AMOD + 11.25% AS |
| D | 77.5% HFCS + 22.5% AMOD |
| E | 77.5% HFCS + 22.5% AS |
| F | 85% HFCS + 10% AMOD + 5% AS with an |
| | additional 0.3% silane |

Key:
HFCS = high fructose corn syrup;
AS = ammonium sulphate;
AMOD = 4-(aminomethyl)-1,8-octanediamine

Binder composition E is a comparative example of binder composition with ammonium sulfate (AS).

Binder composition D showed a higher dry tensile strength than binder composition E. Each of binder compositions A, B and C showed a higher dry tensile strength than binder compositions D.

Binder composition F showed a particularly good wet tensile strength; it is currently believed that the silane additive contributes significantly to this good wet tensile strength.

### Example 5

Examples of binder composition tested on mineral fiber veils are shown in Table 3 with the respective mean dry veil tensile strengths:

In each test, the nitrogen-containing reactant(s) were mixed with glucose in water. The amounts of the reactants used in the binder compositions are expressed in Table 3 as dry weight % and the binder compositions were prepared at 2% solids weight (bake out solids). Once the binder compositions were prepared, they were applied to glass veil which were cured to obtain a quantity of cured binder in the cured veil of 10% LOI (loss on ignition).

The dry tensile strength is measured in the same way as described in example 2.

TABLE 3

| | | Mean |
|---|---|---|
| | | dry tensile |
| Test Ref | Binder composition (% dry weight) | strength (N) |
| G (comparative) | 85% Glu + 15% DAP | 76.5 |
| H (comparative) | 85% Glu + 15% AS | 73.5 |
| I (comparative) | 85% Glu + 15% TriCA | 93.0 |
| J | 85% Glu + 15% AMOD | 81.0 |
| K | 85% Glu + 5% AMOD + 10% DAP | 80.0 |
| L | 85% Glu + 7.5% AMOD + 7.5% DAP | 80.2 |
| M | 85% Glu + 10% AMOD + 5% DAP | 82.4 |
| N | 85% Glu + 5% AMOD + 10% AS | 84.7 |
| O | 85% Glu + 7.5% AMOD + 7.5% AS | 90.0 |
| P | 85% Glu + 10% AMOD + 5% AS | 88.6 |
| Q | 85% Glu + 5% AMOD + 10% TriCa | 88.0 |
| R | 85% Glu + 7.5% AMOD + 7.5% TriCA | 91.4 |
| S | 85% Glu + 10% AMOD + 5% TriCA | 87.9 |

Key:
Glu = glucose;
AS = ammonium sulphate;
DAP = diammonium phosphate;
TriCA = triammonium citrate;
AMOD = 4-(aminomethyl)-1,8-octanediamine

Binder compositions G, H and I are comparative examples of binder compositions with respectively only diammonium phosphate (DAP), ammonium sulfate (AS), and triammonium citrate (TriCa) as nitrogen-containing reactant. Binder composition J is a binder composition wherein the nitrogen-containing reactant consists of AMOD.

In examples K, L and M, the nitrogen-containing reactants consist of AMOD and DAP in different proportions. Examples J, K, L and M shows that similar levels of dry tensile strength are achieved for each of these binder compositions.

In examples N, O and P, the nitrogen-containing reactants consist of AMOD and AS in different proportions. The binder compositions N, O and P present higher dry tensile strengths compared to the result obtained with the binder composition J. Binder composition O seems to present an optimum result compared to binder compositions N and P. It is believed that there is a synergistic effect of the presence of AS and AMOD as the nitrogen-containing reactants.

FIG. 3 illustrates a TPTA triprimary triamine having three primary amines A, B, D with spacer groups which consist of carbon chains between each of its three primary amines. Each carbon atom is numbered to facilitate the explanation below.

The spacer group between primary amines A and B:
has a spacer length of 7, ie carbon atoms 1, 2, 3, 4, 5, 6, 7 which together form the shortest chain of covalently bonded polyvalent atoms between primary amines A and B (the carbon atoms of the two branched chains 8, 9 and 10, 11 do not form part of the spacer length;
has 11 polyvalent atoms, ie carbon atoms 1, 2, 3, 4, 5, 6, 7, 8, 9, 10 and 11 (the carbon atoms 12, 13, 14, 15, 16 do not form part of the spacer group between A and B as they form a chain which connects the third primary amine D to the molecule).

The spacer group between primary amines A and D:
has a spacer length of 10, ie carbon atoms 1, 2, 3, 4, 5, 12, 13, 14, 15, 16;
has 14 polyvalent atoms, ie carbon atoms 1, 2, 3, 4, 5, 8, 9, 10, 11, 12, 13, 14, 15, 16.

The spacer group between primary amines B and D:
has a spacer length of 8, ie carbon atoms 7, 6, 5, 12, 13, 14, 15, 16;
has 10 polyvalent atoms, ie carbon atoms 7, 6, 5, 12, 13, 14, 15, 16, 10, 11 (the chain of carbon atoms 4, 3, 2, 1, 8, 9 does not form part of the spacer group between B and D as this form a chain which connects the other primary amine A to the molecule.

The total number of polyvalent atoms in the molecule is 19, i.e. carbon atoms 1 to 16 and the 3 nitrogen atoms of the 3 primary amines A, B and D.

1. (canceled)

2. A method of manufacturing a composite product, comprising:
applying a binder composition, in the form of an aqueous solution, to non or loosely assembled matter to provide resinated matter, wherein the binder composition consists of a binder composition prepared by combining reactants comprising at least 50% by dry weight reducing sugar reactant(s) and at least 5% by dry weight nitrogen-containing reactant(s); and
arranging the resinated matter to provide loosely arranged resinated matter; and
subjecting the loosely arranged resinated matter to heat and/or pressure to cure the binder composition and to form the composite product;
wherein the nitrogen-containing reactant(s) comprise TPTA triprimary triamine(s), wherein the nitrogen-containing reactant(s) comprise at least 5% by dry weight of TPTA triprimary triamine(s), the TPTA triprimary triamine(s) being organic compound(s) having three and only three amines, each of the amines being primary amines or salts thereof, selected from:
a) triprimary triamine(s) having spacer groups between each of the three primary amines which consist of carbon chains;
b) triprimary triamine(s) having spacer groups between each of the three primary amines wherein each spacer group has a spacer length which is less than or equal to 12 polyvalent atoms; and
c) triprimary triamine(s) having a total number of polyvalent atoms which is less than or equal to 23.

3. A method according to claim 2, wherein the reducing sugar reactant(s) comprise reducing sugar reactant(s) selected from the group consisting of xylose, dextrose, fructose and combinations thereof.

4. A method according to claim 2, wherein the TPTA triprimary triamine(s) consist of triprimary triamine(s) having spacer groups between each of the three primary amines which consist of carbon chains.

5. A method according to claim 2, wherein the nitrogen-containing reactant(s) comprise triprimary triamine(s) selected from the group consisting of triaminodecanes, triaminononanes, triaminooctanes, triaminoheptanes, triaminohexanes, triaminopentanes, and combination thereof.

6. A method according to claim 2, wherein the nitrogen-containing reactant(s) comprise 4-(aminomethyl)-1,8-octanediamine.

7. A method according to claim 2, wherein the binder composition consists of a binder composition prepared by combining reactants consisting of between 60% and 95% by dry weight reducing sugar reactant(s) and between 5% and 40% by dry weight nitrogen-containing reactant(s).

8. A method according to claim 2, wherein the nitrogen-containing reactant(s) comprise at least 95 wt % of TPTA triprimary triamine(s).

9. A method according to claim 2, wherein the nitrogen-containing reactants comprise reactant(s) different from the TPTA triprimary triamine(s), wherein the nitrogen-containing reactants comprise polyprimary polyamine(s), diprimary diamine(s), diprimary diamines selected from the group consisting of 1,6-diaminohexane, 1,5-diamino-2-methylpentane, and combinations thereof.

10. A method according to claim 2, wherein the nitrogen-containing reactants comprise reactant(s) different from the TPTA triprimary triamine(s), wherein the nitrogen-containing reactants comprise inorganic or organic ammonium salt, selected from the group consisting of ammonium sulfate, ammonium phosphate, ammonium citrate, and combinations thereof.

11. A method according to claim 2, wherein the aqueous binder composition is prepared by combining all the reducing sugar reactant(s) and all the nitrogen-containing reactant(s) in a single preparation step.

12. A method according to claim 2, wherein the aqueous binder composition is prepared by combining reducing sugar reactant(s), all of the reducing sugar reactant(s), with a first portion of the nitrogen-containing reactant(s) to provide an intermediate binder composition comprising reaction products of the reducing sugar reactant(s) and the first portion of the nitrogen-containing reactant(s),
storing the intermediate binder composition; and
combining the intermediate binder composition with a second portion of the nitrogen-containing reactant(s) to provide the binder composition.

13. A method according to claim 2, wherein the composite mineral fiber product is a mineral fiber insulation product.

14. A method according to claim 2, wherein the composite mineral fiber product is a mineral fiber veil.

15. A method according to claim 2, wherein in the form in which it is applied to the non or loosely assembled matter, the binder composition comprises, and consists essentially of, curable reaction product(s) of the reducing sugar reactant(s) and the nitrogen-containing reactant(s).

16. A method according to claim 2, wherein the composite product is a composite mineral fiber product selected from a non-woven veil, glass wool insulation and stone wool insulation and wherein the matter is mineral fibers.
